(19) United States
(12) Patent Application Publication
(10) Pub. No.: US 2008/0064364 A1
(43) Pub. Date: Mar. 13, 2008

(54) Emergency group calling across multiple wireless networks

(76) Inventors: Krishnakant M. Patel, Richardson, TX (US); Deepankar Biswas, Bangalore (IN); Sameer P. Dharangaonkar, Bangalore (IN); Terakanambi Nanjanayaka Raja, Bangalore (IN)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/891,127

(22) Filed: Aug. 9, 2007

Related U.S. Application Data
(60) Provisional application No. 60/836,521, filed on Aug. 9, 2006.

(51) Int. Cl. H04M 11/04

(52) U.S. Cl. 455/404.1

(57) ABSTRACT

Emergency group calling services in a wireless network are comprised of mass outbound (MO) voice or text messages sent from an originating mobile unit to all terminating mobile units in response to a single invocation by the originating mobile unit. The emergency group calling services are invoked by transmitting a message from the originating mobile unit to a real-time exchange.

### CROSS REFERENCE TO RELATED APPLICATIONS

This application claims the benefit under 35 U.S.C. Section 119(e) of the following co-pending and commonly-assigned patent application:

U.S. Provisional Application Ser. No. 60/836,521, filed on Aug. 9, 2005, by Krishnakant M. Patel, Deepankar Biswas, Sameer P. Dharangaonkar, and Terakanambi Nanjanayaka Raja, entitled “SOLUTION FOR EMERGENCY GROUP CALLING ACROSS MULTIPLE OPERATORS,” attorneys' docket number 154.27-US-P1,

which application is incorporated by reference herein.

This application is related to the following co-pending and commonly-assigned patent applications:

U.S. Utility application Ser. No. 10/515,556, filed Nov. 23, 2004, by Gorachand Kundu, Ravi Ayyasamy and Krishnakant Patel, entitled “DISPATCH SERVICE ARCHITECTURE FRAMEWORK,” attorney docket number G&C 154.4-US-WO, which application claims the benefit under 35 U.S.C. Section 365 of P.C.T. International Patent Application Serial Number PCT/US03/16386 (154.4-WO-U1), which application claims the benefit under 35 U.S.C. Section 119(e) of U.S. Provisional Patent Application Ser. Nos. 60/382,981 (154.3-US-P1), 60/383,179 (154.4-US-P1) and 60/407,168 (154.5-US-P1);

U.S. Utility application Ser. No. 10/564,903, filed Jan. 17, 2006, by F. Craig Farrill, Bruce D. Lawler and Krishnakant M. Patel, entitled “PREMIUM VOICE SERVICES FOR WIRELESS COMMUNICATIONS SYSTEMS,” attorney docket number G&C 154.7-US-WO, which application claims the benefit under 35 U.S.C. Section 365 of P.C.T. International Patent Application Serial Number PCT/US04/23038 (154.7-WO-U1), which application claims the benefit under 35 U.S.C. Section 119(e) of U.S. Provisional Patent Application Ser. Nos. 60/488,638 (154.7-US-P1), 60/492,650 (154.8-US-P1) and 60/576,094 (154.14-US-P1) and which application is a continuation-in-part and claims the benefit under 35 U.S.C. Sections 119, 120 and/or 365 of P.C.T. International Patent Application Serial Number PCT/US03/16386 (154.4-WO-U1);

U.S. patent application Ser. No. 11/126,587, filed May 11, 2005, by Ravi Ayyasamy and Krishnakant M. Patel, entitled “ARCHITECTURE, CLIENT SPECIFICATION AND APPLICATION PROGRAMMING INTERFACE (API) FOR SUPPORTING ADVANCED VOICE SERVICES (AVS) INCLUDING PUSH TO TALK ON WIRELESS MS 120 AND NETWORKS,” attorney docket number 154.9-US-U1, which application claims the benefit under 35 U.S.C. Section 119(e) of U.S. Provisional Patent Application Ser. Nos. 60/569,953 (154.9-US-P1) and 60/579,309 (154.15-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);

U.S. Utility patent application Ser. No. 11/129,268, filed May 13, 2005, by Krishnakant M. Patel, Gorachand Kundu, Ravi Ayyasamy and Basem Ardah, entitled “ROAMING GATEWAY FOR SUPPORT OF ADVANCED VOICE SERVICES WHILE ROAMING IN WIRELESS COMMUNICATIONS SYSTEMS,” attorney docket number 154.10-US-U1, which application claims the benefit under 35 U.S.C. Section 119(e) of U.S. Provisional Patent Application Ser. No. 60/571,075 (154.10-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);

U.S. Utility patent application Ser. No. 11/134,883, filed May 23, 2005, by Krishnakant Patel, Vyankatesh V. Shanbhag, Ravi Ayyasamy, Stephen R. Horton and Shan-Jen Chiou, entitled “ADVANCED VOICE SERVICES ARCHITECTURE FRAMEWORK,” attorney docket number 154.11-US-U1, which application claims the benefit under 35 U.S.C. Section 119(e) of U.S. Provisional Patent Application Ser. Nos. 60/573,059 (154.11-US-P1) and 60/576,092 (154.12-US-P1), and which application is a continuation-in-part and claims the benefit under 35 U.S.C. Sections 119, 120 and/or 365 of U.S. Utility patent application Ser. No. 10/515,556 (154.4-US-WO), P.C.T. International Patent Application Serial Number PCT/US04/23038 (154.7-WO-U1), U.S. Utility patent application Ser. No. 11/126,587 (154.9-US-U1), and U.S. Utility patent application Ser. No. 11/129,268 (154.10-US-U1);

U.S. Utility patent application Ser. No. 11/136,233, filed May 24, 2005, by Krishnakant M. Patel, Vyankatesh Vasant Shanbhag, and Anand Narayanan, entitled “SUBSCRIBER INFORMATION MODULE (SIM) ENABLING ADVANCED VOICE SERVICES (AVS) INCLUDING PUSH TO TALK ON WIRELESS MS 120 AND NETWORKS,” attorney docket number 154.13-US-U1, which application claims the benefit under 35 U.S.C. Section 119(e) of U.S. Provisional Patent Application Ser. No. 60/573,780 (154.13-US-P1), and which application is a continuation-in-part and claims the benefit under 35 U.S.C. Sections 119, 120 and/or 365 of U.S. Utility patent application Ser. No. 10/515,556 (154.4-US-WO), P.C.T. International Patent Application Serial Number PCT/US04/23038 (154.7-WO-U1), U.S. Utility patent application Ser. No. 11/126,587 (154.9-US-U1), and U.S. Utility patent application Ser. No. 11/134,883 (154.11-US-U1);

U.S. Utility patent application Ser. No. 11/158,527, filed Jun. 22, 2005, by F. Craig Farrill, entitled “PRESS-TO-CONNECT FOR WIRELESS COMMUNICATIONS SYSTEMS,” attorney docket number 154.16-US-U1, which application claims the benefit under 35 U.S.C. Section 119(e) of U.S. Provisional Patent Application Ser. No. 60/581,954 (154.16-US-P1), and which application is a continuation-in-part and claims the benefit under 35 U.S.C. Sections 119, 120 and/or 365 of U.S. Utility patent application Ser. No. 10/515,556 (154.4-US-WO) and P.C.T. International Patent Application Serial Number PCT/US04/23038 (154.7-WO-U1);

U.S. Utility patent application Ser. No. 11/183,516, filed Jul. 18, 2005, by Deepankar Biswaas, entitled “VIRTUAL PUSH TO TALK (PTT) AND PUSH TO SHARE (PTS) FOR WIRELESS COMMUNICATIONS SYSTEMS,” attorney docket number 154.17-US-U1, which application claims the benefit under 35 U.S.C. Section 119(e) of U.S. Provisional Patent Application Ser. No. 60/588,464 (154.17-US-P1);

U.S. Utility patent application Ser. No. 11/356,775, filed Feb. 17, 2006, by Krishnakant M. Patel, Bruce D. Lawler, Giridhar K. Boray, and Brahmananda R. Vempati, entitled “ENHANCED FEATURES IN AN ADVANCED VOICE SERVICES (AVS) FRAMEWORK FOR WIRELESS COMMUNICATIONS SYSTEMS,” attorney docket number 154.18-US-U1, which application claims the benefit under 35 U.S.C. Section 119(e) of U.S. Provisional Patent Application Ser. No. 60/654,271(154.18-US-P1);

P.C.T. International Patent Application Serial Number PCT/US2006/011628, filed Mar. 30, 2006, by Krishnakant M. Patel, Gorachand Kundu, Sameer Dharangaonkar, Giridhar K. Boray, and Deepankar Biswas, entitled “TECHNIQUE FOR IMPLEMENTING ADVANCED VOICE SERVICES USING AN UNSTRUCTURED SUPPLEMENTARY SERVICE DATA (USSD) INTERFACE,” attorney docket number 154.19-WO-U1, which application claims the benefit under 35 U.S.C. Section 119(e) of U.S. Provisional Patent Application Ser. No. 60/666,424 (154.19-US-P1);

U.S. Utility patent application Ser. No. 11/462,332, filed Aug. 3, 2006, by Deepankar Biswas, Krishnakant M. Patel, Giridhar K. Boray, and Gorachand Kundu, entitled “ARCHITECTURE AND IMPLEMENTATION OF CLOSED USER GROUP AND LIMITING MOBILITY IN WIRELESS NETWORKS,” attorney docket number 154.20-US-U1, which application claims the benefit under 35 U.S.C. Section 119(e) of U.S. Provisional Patent Application Ser. No. 60/705,115 (154.20-US-P1);

U.S. Utility patent application Ser. No. 11/463,186, filed Aug. 8, 2006, by Ravi Ayyasamy and Krishnakant M. Patel, entitled “ADVANCED VOICE SERVICES CLIENT FOR BREW PLATFORM,” attorney docket number 154.21-US-U1, which application claims the benefit under 35 U.S.C. Section 119(e) of U.S. Provisional Patent Application Ser. No. 60/706,265 (154.21-US-P1);

U.S. Utility patent application Ser. No. 11/567,098, filed Dec. 5, 2006, by Ravi Ayyasamy, Bruce D. Lawler, Krishnakant M. Patel, Vyankatesh V. Shanbhag, Brahmananda R. Vempati, and Ravi Shankar Kumar, entitled “INSTANT MESSAGING INTERWORKING IN AN ADVANCED VOICE SERVICES (AVS) FRAMEWORK FOR WIRELESS COMMUNICATIONS SYSTEMS,” attorney docket number 154.23-US-U1, which application claims the benefit under 35 U.S.C. Section 119(e) of U.S. Provisional Patent Application Ser. No. 60/742,250 (154.23-US-P1); and

U.S. Utility patent application Ser. No. 11/740,805, filed Apr. 26, 2007, by Krishnakant M. Patel, Giridhar K. Boray, Ravi Ayyasamy, and Gorachand Kundu, entitled “ADVANCED FEATURES ON A REAL-TIME EXCHANGE SYSTEM,” attorney docket number 154.26-US-U1, which application claims the benefit under 35 U.S.C. Section 119(e) of U.S. Provisional Patent Application Ser. No. 60/795,090 (154.26-US-P1);

all of which applications are incorporated by reference herein.

### BACKGROUND OF THE INVENTION

1. Field of the Invention

This invention relates in general to wireless communications systems, and more specifically, to a solution for emergency group calling services across multiple wireless networks.

2. Description of Related Art

Advanced voice services (AVS), also known as Advanced Group Services (AGS), such as two-way half-duplex voice calls within a group, also known as Push-to-Talk (PTT) or Press-to-Talk (P2T), as well as other AVS functions, such as Push-to-Conference (P2C) or Instant Conferencing, Push-to-Message (P2M), etc., are described in the co-pending and commonly-assigned patent applications cross-referenced above and incorporated by reference herein. These AGS functions have enormous revenue earnings potential for wireless communications systems, such as cellular networks and personal communications systems (PCS) networks.

Currently, there are three major approaches employed in providing advanced voice services in wireless communications systems. One approach requires the installation of a dedicated private network, parallel to the wireless communications system, to support the group-based voice services. NEXTEL uses such a system, based on a solution developed by MOTOROLA known as IDEN. However, a dedicated private network is costly to install and maintain and is employed by a few public wireless carriers. Also, the IDEN system is non-standard, and hence cannot be used in standard wireless communications networks, such as those based on GSM (Global System for Mobile Communications) and CDMA (Code Division Multiple Access).

Another approach is based on Voice over IP (VoIP) technologies. While this approach promises compliance with newer and emerging standards, such as GPRS (General Packet Radio Service), UMTS (Universal Mobile Telecommunications System), etc., it does not provide a solution for carriers employing wireless communications systems based on existing standards, such as GSM, CDMA, etc. However, even for the newer standards, solutions based on VoIP have serious drawbacks, including slower call setup, significant overhead, increased susceptibility to packet losses, low bit rate voice coders, and significant modifications to the mobile handset. There is a need, instead, for solutions that require only minimal upgrades to the handset.

Still another approach is that defined in the co-pending and commonly-assigned patent applications cross-referenced above and incorporated by reference herein. In this approach, advanced voice services are provided by a dispatch gateway (DG) or real-time exchange (RTX) that interfaces to the wireless communications system to provide the advanced voice services therein, wherein both the dispatch gateway and mobiles that use the advanced voice services communicate with each other using call setup and in-band signaling within the wireless communications system.

Notwithstanding these innovations, there is a need in the art for other advanced voice services that comply with existing and emerging wireless standards and provide superior user experiences. The present invention aims to satisfy this need by providing emergency group calling services for wireless communications systems.

### SUMMARY OF THE INVENTION

To overcome the limitations in the prior art described above, and to overcome other limitations that will become apparent upon reading and understanding the present specification, the present invention discloses emergency group calling services in a wireless network, wherein the emergency group calling services comprise mass outbound (MO) voice or text messages sent from an originating mobile unit to all terminating mobile units in response to a single invocation by the originating mobile unit. The emergency group calling services are invoked by transmitting a message from the originating mobile unit to a real-time exchange.

In a first approach, users of the emergency group calling services each have two or more network subscriptions, wherein each subscription is provisioned in a different network. Each subscription is stored in the user's mobile unit, and each real-time exchange stores a subscriber profile database with records of the network subscriptions associated with each user. In response to the invocation of the emergency group calling services, the real-time exchange sends a connection request to numbers corresponding to each of the network subscriptions associated with a user, although the real-time exchange performs the call setup only to the connection request that is successful.

In a second approach, users of the emergency group calling service each have only one network subscription, wherein the subscription is provisioned in a single network. However, each real-time exchange stores a subscriber profile database with records of the users subscribing to the emergency group calling services, even if the user is not a subscriber to the real-time exchange's network. Thus, the real-time exchange recognizes the mobile unit as a subscriber to the emergency group calling service.

### BRIEF DESCRIPTION OF THE DRAWINGS

Referring now to the drawings in which like reference numbers represent corresponding parts throughout:

FIG. 1 is a block diagram that illustrates an exemplary embodiment of a wireless communications network according to a preferred embodiment of the present invention;

FIG. 2 illustrates a proposed architecture for a real-time exchange according to the preferred embodiment of the present invention;

FIG. 3 illustrates the high-level functional components and their interfaces for a mobile station or handset according to a preferred embodiment of the present invention; and

FIG. 4 is an illustration of an exemplary system used for the emergency group calling services according to the preferred embodiment of the present invention.

### DETAILED DESCRIPTION OF THE INVENTION

In the following description of the preferred embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

Overview

The present invention comprises an Advanced Group Services (AGS) disaster communications solution for wireless networks. This solution provides for emergency or “SOS” group calling services among wireless network users, wherein the emergency group calling services comprise mass outbound (MO) voice or text messages sent from an originating mobile unit to all terminating mobile units in response to a single invocation by the originating mobile unit. Thus, it has applicability not only to normal subscribers of wireless networks, but also to government ministry officials, police groups, military groups, etc. The goal of the present invention is to provide a mechanism for communicating to all members of a group during an emergency or crisis.

Network Architecture

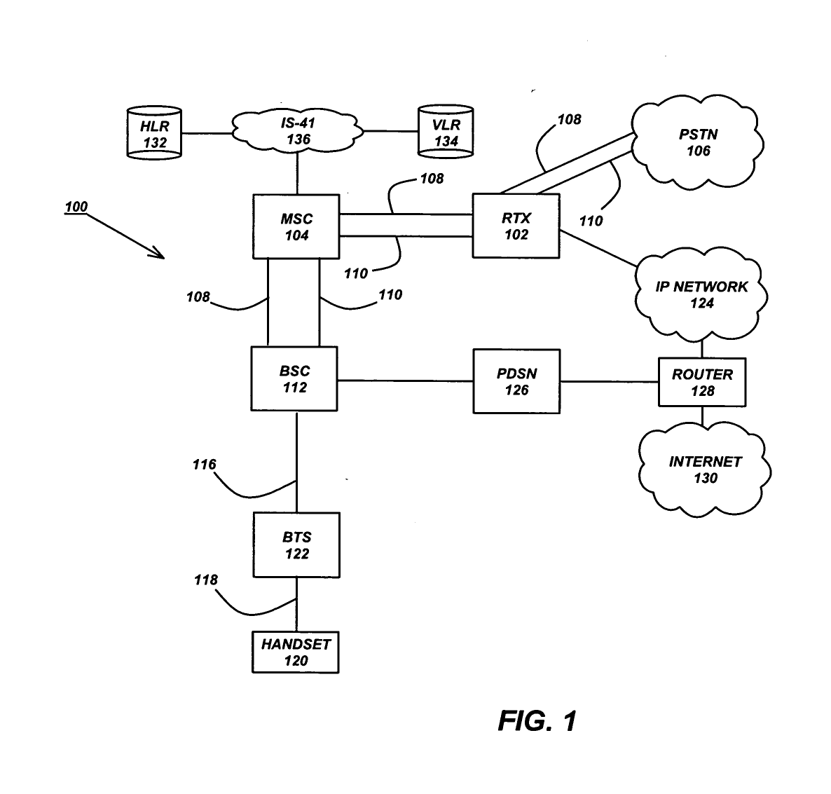

FIG. 1 is a block diagram that illustrates an exemplary embodiment of a wireless communications network according to a preferred embodiment of the present invention.

Within the network 100, an RTX (Real-Time Exchange) 102, previously known as a Dispatch Gateway (DG), communicates with a MSC (Mobile Switching Center) 104 and PSTN (Public Switched Telephone Network) 106 using SS7—ISUP/WIN/CAMEL (Signaling System 7—Integrated Services Digital Network User Part/Wireless Intelligent Network/Customized Applications for Mobile Enhanced Logic) messages at a signaling plane 108. A bearer path 110 implements a TDM (Time Division Multiplexing) interface carrying PCM (Pulse Code Modulation) or TFO (Tandem Free Operation) voice frames. Support for TFO in this path 110 is negotiated between a BSC (Base Station Controller) 112 and the RTX 102 for each originating and terminating leg of an AGS call. The use of TFO ensures high voice quality (as voice vocoder conversion is avoided) between mobile-to-mobile calls.

When a subscriber originates an AGS call, the MSC 104 routes the call to the RTX 102. The MSC 104 also requests the BSC 112 via 116 to establish a radio traffic path 118 with a mobile station (MS) 120 (also known as a handset or mobile unit) via the BTS (Base Transceiver Station) 122 (as it does for a normal cellular call). At this time, the BSC 112 tries to negotiate TFO (if it is supported) on a TDM link with the far end (in this case, the RTX 102).

At the same time (after the MSC 104 terminates the group call request to the RTX 102), the RTX 102 identifies the terminating group users and their numbers, which may comprise an MS-ISDN (Mobile Station—Integrated Services Digital Network) number, an IMSI (International Mobile Subscriber Identity) number, or an MDN (Mobile Directory Number).

The RTX 102 sends an ISUP call origination request for each terminating MS 120. It may send requests directly to the MSC 104, PSTN 106 or IP network 124 via a PDSN (Public Data Switched Network) 126, Router 128, and/or Internet/Intranet 130, depending on the routing table configuration for terminating numbers. Once the bearer path 110 is established, the RTX 102 begins a negotiation with the far end (in this case, the terminating BSC 112) for each terminating leg to an MS 120.

Once bearer paths 110 are established for originating and terminating legs for an AGS call, the RTX 102 switches (or duplicates) voice or data from the originating MS 120 to all terminating MS's 120.

The RTX 102 may use an IP network 124 or the Internet/Intranet 130 for two different purposes. The IP network 124 or the Internet/Intranet 130 can be used in a toll bypass mode where two RTXs 102 can exchange voice traffic bypassing the PSTN 106. However, each RTX 102 is responsible for terminating traffic to its closest MSC 104. In this case, the IP network 124 or the Internet/Intranet 130 is used as a backbone transport of voice traffic between two RTXs 102.

The IP network 124 or the Internet/Intranet 130 can also be used for a registration and presence application. Since the MSC 104 will not direct a registration request from a MS 120 to the RTX 102 (because it would require changes in the MSC 104), the latter does not have any information of the registered MS 120. To circumvent this issue, a registration and presence application runs over an IP stack in the MS 120. After the MS 120 registers for a data interface (i.e., obtaining an IP address) with the PDSN 126 (or Serving GSM Service Nodes (SGSN) in the case of GSM networks), the registration and presence application in the MS 120 registers with the RTX 102 using its IP address. The RTX 102 also uses this IP interface to update the presence information of other group members to an MS 120.

An alternative embodiment would use the SMS (Short Message Service) transport to carry presence messages over a data channel. The RTX 102 interacts with the MS 120 using predefined presence application related messages that are transported as SMS messages. The same messages can be transported via the PDSN 126 interface, if group users have data service.

During roaming, a Home Location Register (HLR) 132 and Visitor Location Register (VLR) 134 can be accessed via the MSC 104 and an IS-41 link 136. The HLR 132 and VLR 134 are used to track the presence of members of a group within home or foreign networks and updates the mobile handsets 120 for those members with the network availability of other members of the group.

Real Time Exchange

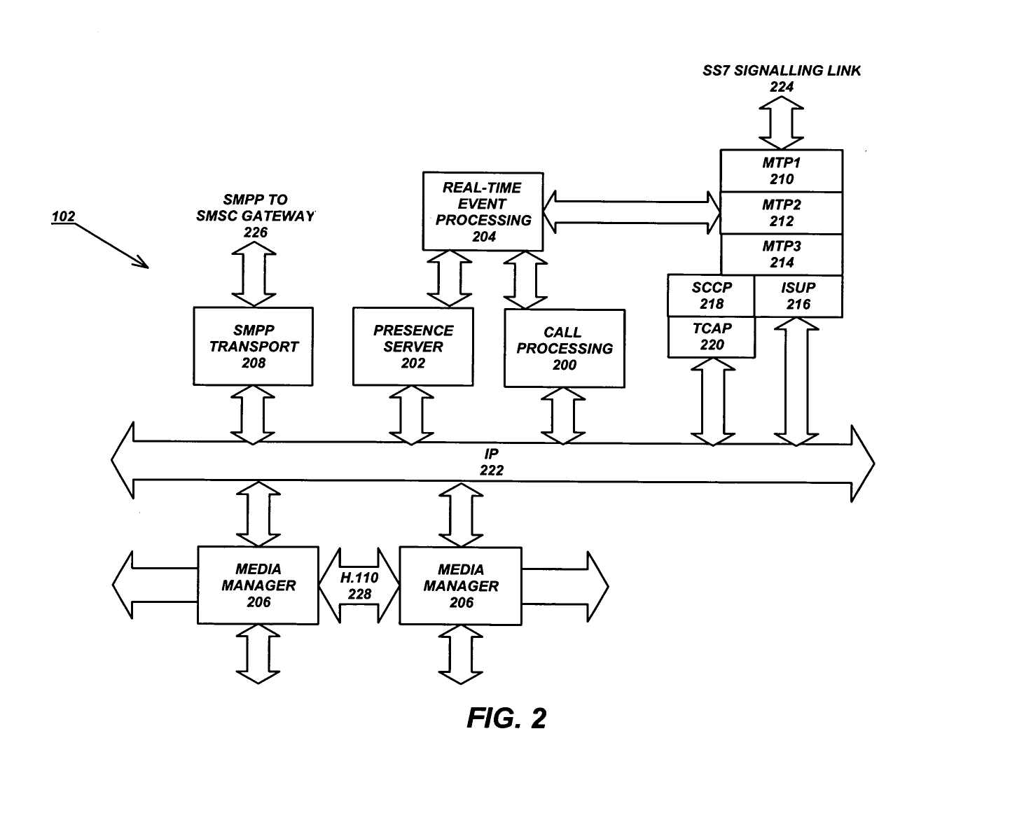

FIG. 2 illustrates a proposed architecture for the RTX 102 according to the preferred embodiment of the present invention.

The architecture includes a Call Processing system 200, Presence Server 202, Real-Time Event Processing system 204, one or more Media Managers 206, and an SMPP (Short Message Peer-to-Peer) Transport 208, as well as modules for various SS7 protocols, such as MTP-1 (Message Transfer Part Level 1) 210, MTP-2 (Message Transfer Part Level 2) 212, MTP-3 (Message Transfer Part Level 3) 214, ISUP (Integrated Services Digital Network User Part) 216, SCCP (Signaling Connection Control Part) 218, and TCAP (Transactions Capabilities Application Part) 220 protocols.

The Call Processing system 200, Presence Server 202, Media Managers 204, SMPP Transport 206, and other modules communicate across an IP network 222. The Real-Time Event Processing system 204 communicates directly with the Call Processing system 200, Presence Server 202, and the modules for various SS7 protocols. The modules for various SS7 protocols communicate with other entities via a SS7 Signaling Link 224. The SMPP Transport 206 communicates with a SMSC (Short Message Service Center) gateway using the SMPP protocol 226. The Media Managers 204 communicate among themselves using the H.110 protocol 228 (or some other protocol, such TCP/IP).

The operation of these various components are described in more detail below, as well as in the co-pending and commonly-assigned patent applications cross-referenced above and incorporated by reference herein.

The originating MS 120 signals the RTX 102 via the wireless network 100, e.g., by transmitting one or more configured DTMF (Dual Tone Multi Frequency) digits to the RTX 102. The Media Manager systems 206 receive the DTMF digits and pass the DTMF digits to the Call Processing system 200. The Call Processing (CP) system 200 determines whether the originating MS 120 has subscribed to the AGS feature before originating the AGS call. Upon confirmation, the Call Processing system 200 initiates a new AGS call. The Call Processing system 200 interacts with the Presence Server 202 and Real-Time Event Processing system 204 to cause the wireless network 100 to perform call setup with the terminating MS's 120 for the AGS call, and thereafter to manage the AGS call.

During the AGS call, the Call Processing system 200 interacts with the Media Manager systems 206 to maintain the H.110 channels 227 and assign any additional H.110 channels 228 required for the AGS call, which may span across multiple Media Manager systems 206. During the AGS call, the Media Manager systems 206 of the RTX 102 are used to mix audio streams between the originating MS 120 and the terminating MS 120, and then deliver these mixed audio streams to the originating MS 120 and the terminating MS 120. The H.110 channels 228 are used for passing mixed and unmixed audio streams voice between the Media Manager systems 200 as required.

Mobile Station Components

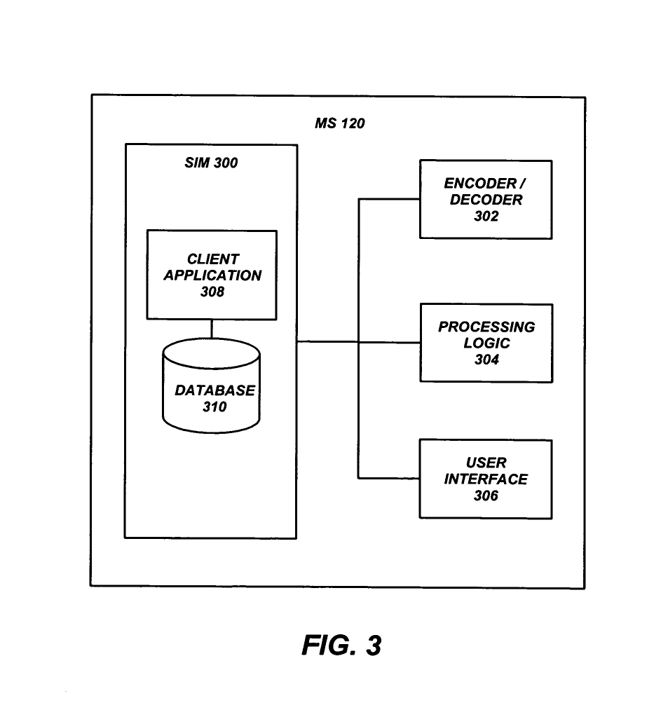

FIG. 3 illustrates the high-level functional components and their interfaces in the MS 120 according to a preferred embodiment of the present invention.

Preferably, the MS 120 includes a Subscriber Identity Module (SIM) 300 that is inserted into the MS 120 to provide the wireless phone service. The SIM 300 stores some of the logic and data required of the MS 120 for providing cellular service, including the functions necessary for the AGS features. In addition, the SIM 132 stores contact and group information, and other user information for use by the MS 120.

The high-level functional components of the MS 120 include an encoder/decoder 302, processing logic 304 and user interface 306. A client application 308 is provided on the SIM 300 that supports AGS functionality for the MS 120. In addition, the SIM 300 stores a database 310, which includes an address book, AGS contacts and/or group information.

At power-on, the MS 120 loads the client application 308 necessary to support the AGS features. This functionality provided includes the “look and feel” of the menu displays on the MS 120, as well as user interaction with the menu displays.

During operation, the encoder/decoder 302 decodes and encodes messages, and populates specific data structures in the MS 120. The encoder/decoder 302 checks the validity of the incoming messages by verifying mandatory parameters for each of the incoming messages. A message will not be processed further if the encoder/decoder 302 fails to decode the message.

The processing logic 304 handles all the AGS related functionalities, such as Group/Private/Dynamic Group calls. The processing logic 304 implementation is device-specific and vendor-specific, and it interacts with the other components, including the encoder/decoder 302, user interface 306, client application 308 and database 310.

The processing logic 304 provides an auto-answer mechanism for AGS calls. Specifically, when a call is received, the processing logic 304 automatically answers the call. The processing logic 304 makes use of call notification for incoming call detection and, based on various parameters received within the call notification, determines whether the call is an AGS call. If the call is an AGS call, then the processing logic 304 uses “AT” commands to answer the AGS call and turn on the speaker of the MS 120. (All of this takes place within a certain time period.) On the other hand, if the call is not an AGS call, then normal call processing is performed by the MS 120.

The processing logic 304 also provides “floor control” using DTMF tone control. In P2T calls, which are half-duplex, a determination of who may talk is based on who has the “floor.” Using the processing logic 304 provided in the MS 120, appropriate DTMF tones are sent to the RTX 102 in accordance with specific key sequences (i.e., pressing and/or releasing a P2T key) that indicate whether the “floor” has been requested and/or released by the user.

In addition, the processing logic 304 provides SMS destination control based on the type of subscriber. At the time of subscriber data provisioning, if it is determined that the MS 120 will use AGS based logic, then appropriate logic is invoked in the RTX 102 to send presence messages over SMS to the MS 120. Similarly, the MS 120 is configured at the time of provisioning to receive/accept such SMS and respond to the RTX 102 appropriately.

Finally, the processing logic 304 also enables subscribers to track the presence of fellow members of the group in the network 100 on their MS 120, and provides a mechanism and API to carry-out contacts and group management operations on the MS 120, such as add member, delete member, etc.

Since most of the presence information is stored in the database 310, the database 310 is tightly integrated with the processing logic 304. The database 310 stores groups, contacts, presence and availability related information. The database 310 information essentially contains group and member information along with presence information associated with each group and member. A part from group and member information, the database 310 also stores subscriber information, such as privileges, presence information, etc. The other components of the MS 120 may interact with the database 310 to retrieve/update the group, members and presence information for various operations. The database 310 also has pointers to the native address book on the MS 120, to provide seamless “alias” naming for contacts used with cellular calls, as well as AGS features.

The user interface 306 provides a mechanism for the user to view and manage groups, group members, contacts, presence and availability. The user interface 306 also makes it possible to invoke the AGS features from the group/contact list screens, as described in more detail below.

Emergency Group Calling Services

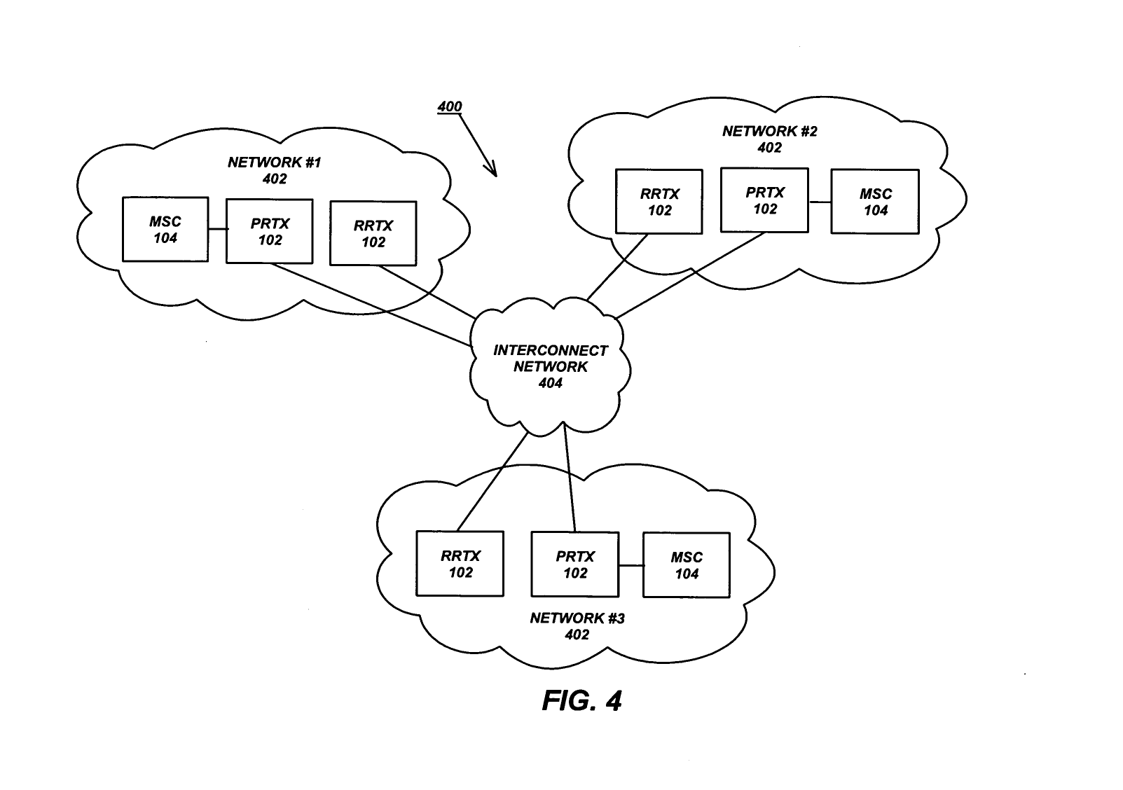

FIG. 4 is an illustration of an exemplary system 400 used for the emergency group calling services according to the preferred embodiment of the present invention. In this exemplary system 400, there are a plurality of wireless networks 402, wherein the networks 402 are connected by means of an interconnection network 404, such as a long distance network. Within each network 402, there is an MSC 104, primary RTX (PRTX) 102 (also known as a serving RTX 102) and an optional roaming RTX (RRTX) 102. The present invention provides two different approaches to implementing the emergency group calling services among wireless network users.

In both approaches, the emergency group calling services are invoked by transmitting a message from the originating MS 120 to the RTX 102, although key aspects of both approaches are quite different, as discussed in more detail below. The emergency group calling services themselves comprise mass outbound (MO) voice or text messages sent from an originating MS 120 to all terminating MS 120 in response to a single invocation by the originating MS 120.

Approach #1: Multiple Subscriptions

In a first approach, users of the emergency group calling services each have two or more network subscriptions, wherein each subscription is provisioned in a different network 402. Each subscription is stored in the SIM 300 of the MS 120. Moreover, each RTX 102 stores a subscriber profile database with records of all network subscriptions associated with each user, as well as necessary group information for performing the emergency calling services.

Assume that an incident occurs in network #1 402 that renders it unavailable or inaccessible, including its HLR 132, which must be available if its subscribers want to roam in foreign networks. Consequently, a user having subscription “A1” in network #1 402 cannot use network #1 402. Moreover, a user having subscription “A1” in network #1 402 cannot roam in network #2 402 or network #3 402, because the HLR 132 in network #1 402 is unavailable or inaccessible.

Using the present invention, however, the user connects or “latches” either to network #2 402 using its associated subscription “A2” or network #3 402 using its associated subscription “A3”.

This may result in the following different scenarios:
a non-AGS or AGS call terminating to A1 or an AGS group that has A1 as a member,
A2 or A3 originating a normal call, and
A2 or A3 originating a normal call or AGS group call.

A Non-AGS or AGS Call Terminating to A1 or an AGS Group that has A1 as a Member

In this scenario, a non-AGS or AGS subscriber attempts a call terminating to A1 or an AGS group that has A1 as a subscriber. Based on the message sent from the originating MS 120, the local MSC 104 forwards the call to the serving RTX 102. The serving RTX 102 receives the message, accesses its database to retrieve the three subscriptions corresponding to A1, A2 and A3, and sends connection requests to the three numbers corresponding to each of the network subscriptions A1, A2 and A3 associated with a user. In this scenario, a connection request for either A2 or A3 will be successful (although only one will succeed and the other will fail), but the connection request for A1 will fail. Upon receipt of the successful connection request, the serving RTX 102 performs the call setup to that connection, i.e., one outgoing call per group member.

A2 or A3 Attempts an Normal Call or an AGS Group Call

In this scenario, A2 or A3 attempts a normal call. In either instance, the call is handled normally by the local MSC 104.

A2 or A3 Attempts an AGS Group Call

In this scenario, A2 or A3 attempts an AGS group call. Based on the message sent from the originating MS 120, the local MSC 104 forwards the call to the serving RTX 102. The serving RTX 102 receives the message, and accesses its database to retrieve the corresponding group information identifying the group members. Because every group member has two or more associated subscriptions, the serving RTX 102 sends out multiple connection requests to the group members. In this scenario, only one of the connection requests for each group member will be successful. Upon receipt of the successful connection request, the serving RTX 102 performs the call setup to that connection, i.e., one outgoing call per group member.

Approach #2: Single Subscription

In a second approach, users of the emergency group calling services each have only one network subscription, and that subscription is provisioned only in a single network. After activation of the emergency group calling services, a message sent from the originating MS 120 triggers the emergency group calling services, which results in the local MSC 104 forwarding the call to the serving RTX 102. The serving RTX 102 receives the message, and accesses its database to retrieve the corresponding group information identifying the group members.

In this embodiment, the serving RTX 102 stores a subscriber profile database with records of users subscribing to the emergency group calling services, even if the user is not a subscriber to the network 402 of the serving RTX 102. As a result, the serving RTX 102 recognizes the MS 120 as a subscriber to the emergency group calling services.

The client application 302 of the SIM 300 in the MS 120 may be pre-programmed to generate these messages, although the user may manually input the messages as well. For example, the messages may comprise a dialed string sequence comprising:

<Emergency Code>+<Call Type+<Group Index>

for each of the groups to which the user belongs, such as:

Group 1: <Emergency Code>+<Call Type>+<Group Index>=19+1+1

Group 2: <Emergency Code>+<Call Type>+<Group Index>=19+1+2

. . .

Group 9: <Emergency Code>+<Call Type>+<Group Index>=19+1+9

wherein the <Emergency Code> provides a trigger that is identified by the local MSC 104 as an emergency group calling services request and results in the request being routed to the serving RTX 102, <Call Type> indicates the type of call to be made (e.g., full duplex, half duplex, etc.), and <Group Index> indicates the group to be called (where the serving RTX 102 accesses its database and retrieves the group information using the <Group Index>). The serving RTX 102, on receiving this message, will then set up the calls to the group.

### CONCLUSION

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing emergency group calling services in a wireless network, comprising:
a plurality of wireless networks for making calls between mobile units, wherein the calls are initiated by call setup and in-band signaling within the wireless networks and voice or text messages are switched between the mobile units across bearer paths within the wireless networks; and
each of the wireless networks including a real-time exchange for providing emergency group calling services therein, wherein both the real-time exchange and the mobile units that use the emergency group calling services communicate with each other using the call setup and in-band signaling within the wireless networks, and the real-time exchange switches the voice or text messages for the emergency group calling services from an originating mobile unit to all terminating mobile units across the bearer paths in the wireless networks;
wherein the emergency group calling services comprise mass outbound (MO) voice or text messages sent from the originating mobile unit to all terminating mobile units in response to a single invocation by the originating mobile unit.

2. The apparatus of claim 1, wherein the emergency group calling services are invoked by transmitting a message from the originating mobile unit to the real-time exchange.

3. The apparatus of claim 2, wherein users of the emergency group calling services each have two or more network subscriptions, and each subscription is provisioned in a different network.

4. The apparatus of claim 3, wherein each subscription is stored in the mobile unit.

5. The apparatus of claim 4, wherein each real-time exchange stores a subscriber profile database with records of all network subscriptions associated with each user.

6. The apparatus of claim 5, wherein the real-time exchange sends a connection request to numbers corresponding to each of the network subscriptions associated with a user.

7. The apparatus of claim 6, wherein the real-time exchange performs the call setup to a connection request that is successful.

8. The apparatus of claim 2, wherein users of the emergency group calling service each have only one network subscription, and the subscription is provisioned in a single network.

9. The apparatus of claim 8, wherein each real-time exchange stores a subscriber profile database with records of the users subscribing to the emergency group calling services, even if the user is not a subscriber to the real-time exchange's network.

10. The apparatus of claim 9, wherein the real-time exchange recognizes the mobile unit as a subscriber to the emergency group calling service.

11. A method of providing emergency group calling services in a wireless network, comprising:
connecting a plurality of wireless networks together for handling calls between mobile units in the wireless networks, wherein the calls are initiated by call setup and in-band signaling within the wireless networks and voice or text messages are switched between the mobile units across bearer paths in the wireless networks; and
interfacing a real-time exchange to each of the wireless networks for providing emergency group calling services therein, wherein both the real-time exchange and the mobile units that use the emergency group calling services communicate with each other using the call setup and in-band signaling within the wireless networks, and the real-time exchange switches the voice or text messages for the emergency group calling services from an originating mobile unit to all terminating mobile units across the bearer paths in the wireless networks;
wherein the emergency group calling services comprise mass outbound (MO) voice or text messages sent from the originating mobile unit to all terminating mobile units in response to a single invocation by the originating mobile unit.

12. The method of claim 11, wherein the emergency group calling services are invoked by transmitting a message from the originating mobile unit to the real-time exchange.

13. The method of claim 12, wherein users of the emergency group calling services each have two or more network subscriptions, and each subscription is provisioned in a different network.

14. The method of claim 13, wherein each subscription is stored in the mobile unit.

15. The method of claim 14, wherein each real-time exchange stores a subscriber profile database with records of all network subscriptions associated with each user.

16. The method of claim 15, wherein the real-time exchange sends a connection request to numbers corresponding to each of the network subscriptions associated with a user.

17. The method of claim 16, wherein the real-time exchange performs the call setup to a connection request that is successful.

18. The method of claim 12, wherein users of the emergency group calling service each have only one network subscription, and the subscription is provisioned in a single network.

19. The method of claim 18, wherein each real-time exchange stores a subscriber profile database with records of the users subscribing to the emergency group calling services, even if the user is not a subscriber to the real-time exchange's network.

20. The method of claim 19, wherein the real-time exchange recognizes the mobile unit as a subscriber to the emergency group calling service.
